(19) United States
(12) Patent Application Publication
(10) Pub. No.: US 2008/0248846 A1
(43) Pub. Date: Oct. 9, 2008

(54) METHOD AND SYSTEM FOR CONDUCTING MULTI-RACE LOTTERY OR PARI-MUTUEL WAGERS

(75) Inventors: Frank Stronach, Oberwaltersderf (AT); Michael A. Neuman, Aurora (CA); Jim McAlpine, Aurora (CA); Michael I. Rockert, Aurora (CA); Gregg A. Scoggins, Ashland, VA (US); John Gallinger, Richmond Hill (CA); Jane Lynn, Newmarket (CA); Rob McKeracher, Aurora (CA); Ronda Redwood, Aurora (CA); Gregory K. Lewis, Basalt, CO (US); Allen Gutterman, Los Angeles, CA (US); Aaron Vercruysse, Sierramadre, CA (US); Steve Keech, Towson, MD (US); Paul Micucci, Aurora (CA)

Correspondence Address: PATENT ADMINISTRATOR;KATTEN MUCHIN ROSENMAN LLP, 2900 K Street NW, Suite 200, WASHINGTON, DC, 20007-5118, US

(73) Assignee: MAGNA ENTERTAINMENT CORPORATION, Ashland, VA (US)

(21) Appl. No.: 11/697,545

(22) Filed: Apr. 6, 2007

(51) Int. Cl. A63F 13/00

(52) U.S. Cl. 463/6

(57) ABSTRACT

A system and a method for conducting a wager, such as a lottery game or a pari-mutuel wager, is provided. In an exemplary embodiment, a series of at least four race events is identified. Each bettor is enabled to make a specified prediction pertaining to the outcome of each of the identified race events. For at least one race, the specified prediction includes an identification of the first four, five, six, or seven finishers in the correct order. For other races, the specified prediction may include an identification of the winner or of one of the first two, three, four, or five finishers. Each wager entry includes predictions for all of the identified race events. Winnings are allocated from a wager pool based on the wager entries having completely correct entries or entries that are correct for most of the race events.

### BACKGROUND OF THE INVENTION

1. Field of the Invention

The present invention relates to lottery games or pari-mutuel wagering games, and more particularly to a method and system for conducting lottery games or pari-mutuel wagers involving selected aspects of outcomes of a series of races.

2. Description of the Related Art

Pari-mutuel wagering essentially includes the placing of wagers by a plurality of individuals on the outcome of an event, wherein the bettors who place “winning” wagers share the betting pool minus a percentage taken out for the management or administration of the wagering activity. For example, pari-mutuel wagering is often associated with racing (e.g., horses or dogs) wherein individuals may place wagers on one or more aspects of the outcome of the race. These aspects may include, for example, which of the participants (also referred to herein as runners) will win the race, the order in which a plurality of runners will finish the race (e.g., exacta—ordered prediction of first and second place; trifecta—ordered prediction of first, second and third place; superfecta—ordered prediction of first through fourth place; etc.), or a runner finishing within a specified range of positions (e.g., a “show” wager for a given runner to finish in either first, second or third place; or a quinella wager for predicting the first and second place finishers regardless of order).

For those individuals who have placed a winning wager such that their prediction matches an actual event outcome, their payout is determined, in part, by the difficulty of the wager (e.g., a show wager vs. a trifecta wager), in part, by the size of the pool as defined by the total amount of wagers placed for a given event and, in part, the specific wagers made by other bettors. Thus, for example, if a defined prize pool is to be paid out to those wagers which selected runner X as the winner and, for example, 20 individual wagers were placed on runner X to win, the prize pool will be divided among those 20 bettors in proportion to the amount each of the 20 individual bettors wagered on such an outcome.

Pari-mutuel wagering is preferred by some individuals because a wager may be “handicapped” in the sense that a bettor may study different facets of an event to make an educated prediction of the outcome of the event prior to placing their wager. For example, in a horse race, a bettor may review the past performances of the horses, the training histories of the horses, the breeding histories of the horses, which jockeys will be participating and other related information. Consideration of such information enables a bettor to make a more educated prediction regarding the outcome of a race or other event.

Many individuals prefer other types of wagering activities, such as slot machines, purchasing of lottery tickets or other conventional wagering activities offered at a casino or a lottery facility, because they find the act of handicapping a pari-mutuel wager to be complex, difficult and time consuming. Furthermore, several hours may pass between the time an individual places a wager on a series of races and the outcome of the wager is made known. Such is in contrast to casino wagering wherein multiple wagers may be placed and the outcome of each be made known in rapid succession such as with slot machines.

There have been various attempts by pari-mutuel venues to attract the individuals who are attracted either to simpler wagering activities or the potential for a larger payout. For example, random wagers, sometimes referred to as “quick picks”, have been offered at pari-mutuel venues to satisfy those patrons which prefer simpler wagering activities. Such a random wager may include an appropriately configured wagering terminal which is configured to randomly choose the outcome of the event (e.g., the winning runner of a race) on which the bettor places his or her wager. These wagers are added to the pool of wagers or, in other words, commingled with handicapped wagers which have been placed in regards to the same event. However, those individuals that are placing random wagers, such as a quick-pick type wager, may feel disadvantaged by the fact that other bettors are handicapping their wagers and, therefore, that such other bettors may have a better chance at winning a portion of the wagering pool.

Other attempts to attract new patrons, including those who may not be comfortable in handicapped-style wagering, include, for example, those set forth in U.S. Pat. No. 6,309,307 issued to Krause et al.; U.S. Pat. No. 6,152,822 issued to Herbert; and U.S. patent application Ser. No. 11/531,355, entitled “Methods and Systems for Conducting Pari-Mutuel Wagers”, filed Sep. 13, 2006. The contents of each of these patents or applications are incorporated herein by reference in their entireties.

The Krause et al. patent generally describes a method of incorporating casino game attributes with a pari-mutuel wagering activity. For example, a black jack-style game may be played wherein a bettor wagers on whether the sum of the numbers assigned to the first four runners to finish a race will be closer to 21, without going over, than will the sum of the numbers assigned to the last four runners to finish the race. It is noted that such a scheme is still amenable to a bettor handicapping his or her wager. However, it is believed that incorporation of familiar casino or sports betting themes will entice new patrons to frequent pari-mutuel venues.

The Herbert patent generally describes a method of wagering which includes an activity occurring subsequent to at least one pari-mutuel event and which utilizes the outcome of the one or more pari-mutuel events as a “wagering base” for a slot machine type wagering activity. For example, the win, show, exacta and perfecta results of one or more races are selected to comprise the “wagering” base or, in other words, act as the possible outcomes of a slot machine format wagering activity. The odds which were associated with the selected outcomes of the pari-mutuel wagers (win, show, etc.) may be programmed into an appropriate wagering device or system such that, for example, if the odds of a selected perfecta wager (from a previously run race) were 24 to 1 (i.e., a probability of 0.04), the same probability will be assigned to the selected perfecta wager as a potential outcome of the slot machine-style wagering activity. Outcomes from multiple pari-mutuel events or races may be used to build the wagering base and the actual outcome of a “spin” of the slot machine wagering activity is determined by a random number generator based on the probabilities assigned to the various potential outcomes drawn from the wagering base. It is again noted that the slot machine wagering activity is conducted separately from the pari-mutuel events.

Even with schemes such as described in the above-referenced Krause et al., and Herbert patents, other aspects of pari-mutuel wagering stand in need of improvement. For example, an important factor in attracting patron interest is the size of the probable jackpot that a patron can expect to win. Thus, it is desirable to provide relatively large jackpots.

In view of the shortcomings in the art, it would be advantageous to provide a lottery-type game or a method of pari-mutuel wagering which is attractive to a wide variety of patrons and provides for increased jackpots. It would also be advantageous to provide a method of playing a lottery-type game or placing a pari-mutuel wager with a simplified wagering process such that reduces some of the complexity commonly associated with the pari-mutuel form of wagering. Finally, it would also be advantageous to offer multiple prize tiers so that less experienced bettors, including lottery players, have an improved opportunity to win despite not being an experienced handicapper.

### SUMMARY OF THE INVENTION

In one aspect, the invention provides a method for conducting a wager. The method includes the steps of identifying at least four race events, each race event having a predetermined minimum number of participants; defining the wager by specifying a predictive outcome for each race event; receiving at least one wager entry, the at least one wager entry including a prediction corresponding to the specified predictive outcome for each race event; comparing each actual outcome to each predictive outcome for each received wager entry after an actual outcome for each race event has been determined; and, for each received wager entry, determining a level of winnings to be awarded based on a result of the comparing step. For at least a first one of the at least four race events, the specified predictive outcome includes an identification of at least a first-place finisher, a second-place finisher, a third-place finisher, and a fourth-place finisher in a correct order of finish. For at least a second one of the at least four race events, the specified predictive outcome may include an identification of a first-place finisher. For at least a third one of the at least four race events, the specified predictive outcome may include an identification of one of a first-place finisher and a second-place finisher. Each of the at least four race events may include at least seven participants. The step of determining a level of winnings to be awarded further may include selecting a highest level of winnings corresponding to a correct match between the predictive outcome and the actual outcome for all of the at least four race events and selecting at least a second highest level of winnings corresponding to a correct match between the predictive outcome and the actual outcome for all but one of the at least four events, including a correct match corresponding to the first one of the at least four race events.

The identifying step may further include identifying at least six horse race events. A first one of the at least six horse race events may have a predetermined minimum number of participant horses that is greater than or equal to seven. For the first one of the at least six horse race events, the specified predictive outcome may include an identification of at least a first-place finisher, a second-place finisher, a third-place finisher, a fourth-place finisher, a fifth-place finisher, a sixth-place finisher, and a seventh-place finisher in a correct order of finish. For a second one of the at least six horse race events, the specified predictive outcome may include an identification of a first-place finisher. For a third one of the at least six horse race events, the specified predictive outcome may include an identification of one of a first-place finisher and a second-place finisher. For a fourth one of the at least six horse race events, the specified predictive outcome may include an identification of one of a first-place finisher, a second-place finisher, and a third-place finisher. For a fifth one of the at least six horse race events, the specified predictive outcome may include an identification of one of a first-place finisher, a second-place finisher, a third-place finisher, and a fourth-place finisher. For a sixth one of the at least six horse race events, the specified predictive outcome may include an identification of one of a first-place finisher, a second-place finisher, a third-place finisher, a fourth-place finisher, and a fifth-place finisher.

The step of determining a level of winnings may further include determining a first level of winnings corresponding to a correct match between the predictive outcome and the actual outcome for all of the at least six horse race events, and determining a second level of winnings corresponding to a correct match between the predictive outcome and the actual outcome for the first event and four of the second, third, fourth, fifth, and sixth horse race events. The step of determining a level of winnings may further include determining at least one of a third, fourth, fifth, and sixth level of winnings. The third level may correspond to a correct match between the predictive outcome and the actual outcome for the first horse race event and three of the second, third, fourth, fifth, and sixth horse race events. The fourth level may correspond to a correct match between the predictive outcome and the actual outcome for the first horse race event and two of the second, third, fourth, fifth, and sixth horse race events. The fifth level may correspond to a correct match between the predictive outcome and the actual outcome for the first horse race event and one of the second, third, fourth, fifth, and sixth horse race events. The sixth level may correspond to a correct match between the predictive outcome and the actual outcome for all five of the second, third, fourth, fifth, and sixth horse race events and an incorrect match between the predictive outcome and the actual outcome for the first horse race event. The step of determining a level of winnings may further include determining another level of winnings corresponding to a correct match between the predictive outcome and the actual outcome for one or more of the second, third, fourth, fifth, and sixth horse race events and a correct identification of the first-place finisher, the second-place finisher, the third-place finisher, the fourth-place finisher, the fifth-place finisher, the sixth-place finisher, and the seventh-place finisher in an incorrect order of finish.

In another aspect, the invention provides a system for conducting a wager. The system includes a server computer and at least one client computer. The client computer is in communication with the server computer via a network. The server computer is configured to communicate a set of parameters defining the wager to the at least one client computer. The parameters include an identification of at least four race events and a specified predictive outcome for each race event. The server computer is further configured to receive from the at least one client computer at least one wager entry which includes a prediction corresponding to the specified predictive outcome for each race event. After an actual outcome for each race event has been determined, the server computer is further configured to compare the actual outcome to the specified predictive outcome for each race event for each received wager entry and, based on a result of the comparing, to determine a level of winnings to be awarded for each received wager entry. For at least one of the at least four race events, the specified predictive outcome includes an identification of at least a first-place finisher, a second-place finisher, a third-place finisher, and a fourth-place finisher in a correct order of finish. For at least a second one of the at least four race events, the specified predictive outcome may include an identification of a first-place finisher. For at least a third one of the at least four race events, the specified predictive outcome may include an identification of one of a first-place finisher and a second-place finisher. Each of the at least four race events may include at least seven participants. The server computer may be further configured to determine a highest level of winnings corresponding to a correct match between the predictive outcome and the actual outcome for all of the at least four race events, and to determine at least a second highest level of winnings corresponding to a correct match between the predictive outcome and the actual outcome for all but one of the at least four events, including a correct match corresponding to the first one of the at least four race events.

The server computer may be further configured to communicate a set of parameters, the parameters including an identification of at least six horse race events. A first one of the at least six horse race events may have a predetermined minimum number of participant horses that is greater than or equal to seven. For the first one of the at least six horse race events, the specified predictive outcome may include an identification of at least a first-place finisher, a second-place finisher, a third-place finisher, a fourth-place finisher, a fifth-place finisher, a sixth-place finisher, and a seventh-place finisher in a correct order of finish. For a second one of the at least six horse race events, the specified predictive outcome may include an identification of a first-place finisher. For a third one of the at least six horse race events, the specified predictive outcome may include an identification of one of a first-place finisher and a second-place finisher. For a fourth one of the at least six horse race events, the specified predictive outcome may include an identification of one of a first-place finisher, a second-place finisher, and a third-place finisher. For a fifth one of the at least six horse race events, the specified predictive outcome may include an identification of one of a first-place finisher, a second-place finisher, a third-place finisher, and a fourth-place finisher. For a sixth one of the at least six horse race events, the specified predictive outcome may include an identification of one of a first-place finisher, a second-place finisher, a third-place finisher, a fourth-place finisher, and a fifth-place finisher.

The server computer may be further configured to determine a first level of winnings corresponding to a correct match between the predictive outcome and the actual outcome for all of the at least six race events, and to determine a second level of winnings corresponding to a correct match between the predictive outcome and the actual outcome for the first event and four of the second, third, fourth, fifth, and sixth race events. The server computer may be further configured to determine at least one of a third, fourth, fifth, and sixth level of winnings. The third level may correspond to a correct match between the predictive outcome and the actual outcome for the first horse race event and three of the second, third, fourth, fifth, and sixth horse race events. The fourth level may correspond to a correct match between the predictive outcome and the actual outcome for the first horse race event and two of the second, third, fourth, fifth, and sixth horse race events. The fifth level may correspond to a correct match between the predictive outcome and the actual outcome for the first horse race event and one of the second, third, fourth, fifth, and sixth horse race events. The sixth level may correspond to a correct match between the predictive outcome and the actual outcome for all five of the second, third, fourth, fifth, and sixth horse race events and an incorrect match between the predictive outcome and the actual outcome for the first horse race event. The server computer may be further configured to determine another level of winnings corresponding to a correct match between the predictive outcome and the actual outcome for one or more of the second, third, fourth, fifth, and sixth race events and a correct identification of the first-place finisher, the second-place finisher, the third-place finisher, the fourth-place finisher, the fifth-place finisher, the sixth-place finisher, and the seventh-place finisher in an incorrect order of finish.

In yet another aspect, the invention provides a wagering game. The game includes a plurality of wager entries and a wagering pool. Each of the plurality of wager entries includes a predictive outcome for each of at least four predetermined race events. When an actual outcome for each race event has been determined, a percentage amount of the wagering pool is allocated to each of the plurality of wager entries based on a comparison of each predictive outcome to each actual outcome. For at least one of the at least four predetermined race events, the predictive outcome includes an identification of at least a first-place finisher, a second-place finisher, a third-place finisher, and a fourth-place finisher in a correct order of finish. For at least a second one of the at least four race events, the predictive outcome may include an identification of a first-place finisher. For at least a third one of the at least four race events, the predictive outcome may include an identification of one of a first-place finisher and a second-place finisher. Each of the at least four race events may include at least seven participants. A highest percentage of the wagering pool may be allocated to a wager entry that includes a predictive outcome that correctly matches the actual outcome for all of the at least four race events. A second highest percentage of the wagering pool may be allocated to a wager entry that includes a predictive outcome that correctly matches the actual outcome for all but one of the at least four events, including a predictive outcome that correctly matches the actual outcome for the first one of the at least four race events.

Each of the plurality of wager entries may include a predictive outcome of each of at least six predetermined horse race events. A first one of the at least six horse race events may have a predetermined minimum number of participant horses that is greater than or equal to seven. For the first one of the at least six horse race events, the predictive outcome may include an identification of at least a first-place finisher, a second-place finisher, a third-place finisher, a fourth-place finisher, a fifth-place finisher, a sixth-place finisher, and a seventh-place finisher in a correct order of finish. For a second one of the at least six horse race events, the predictive outcome may include an identification of a first-place finisher. For a third one of the at least six horse race events, the predictive outcome may include an identification of one of a first-place finisher and a second-place finisher. For a fourth one of the at least six horse race events, the predictive outcome may include an identification of one of a first-place finisher, a second-place finisher, and a third-place finisher. For a fifth one of the at least six horse race events, the predictive outcome may include an identification of one of a first-place finisher, a second-place finisher, a third-place finisher, and a fourth-place finisher. For a sixth one of the at least six horse race events, the predictive outcome may include an identification of one of a first-place finisher, a second-place finisher, a third-place finisher, a fourth-place finisher, and a fifth-place finisher.

A first level of winnings from the wagering pool may be allocated to a wager entry that includes a predictive outcome that correctly matches the actual outcome for all of the at least six horse race events, and a second level of winnings from the wagering pool may be allocated to a wager entry that includes a predictive outcome that correctly matches the actual outcome for the first event and four of the second, third, fourth, fifth, and sixth horse race events. At least one of a third, fourth, fifth, and sixth level of winnings from the wagering pool may be allocated to a respective wager entry. The third level of winnings may correspond to a wager entry that includes a correct match between the predictive outcome and the actual outcome for the first horse race event and three of the second, third, fourth, fifth, and sixth horse race events. The fourth level of winnings may correspond to a wager entry that includes a correct match between the predictive outcome and the actual outcome for the first horse race event and two of the second, third, fourth, fifth, and sixth horse race events. The fifth level of winnings may correspond to a wager entry that includes a correct match between the predictive outcome and the actual outcome for the first horse race event and one of the second, third, fourth, fifth, and sixth horse race events. The sixth level of winnings may correspond to a wager entry that includes a correct match between the predictive outcome and the actual outcome for the first horse race event and none of the second, third, fourth, fifth, and sixth horse race events. The seventh level of winnings may correspond to a wager entry that includes a correct match between the predictive outcome and the actual outcome for all five of the second, third, fourth, fifth, and sixth horse race events and an incorrect match between the predictive outcome and the actual outcome for the first horse race event. Another level of winnings from the wagering pool may be allocated to a wager entry that includes a predictive outcome that correctly matches the actual outcome for one or more of the second, third, fourth, fifth, and sixth horse race events and a correct identification of the first-place finisher, the second-place finisher, the third-place finisher, the fourth-place finisher, the fifth-place finisher, the sixth-place finisher, and the seventh-place finisher in an incorrect order of finish.

### BRIEF DESCRIPTION OF THE DRAWINGS

FIG. 1 is a block diagram of a system for conducting a wagering game according to a preferred embodiment of the present invention.

FIG. 2 is a flow chart that illustrates a method of conducting a wagering game according to a preferred embodiment of the present invention.

FIG. 3 is a table that displays estimated maximum odds of winning for an exemplary set of horse races according to a preferred embodiment of the present invention.

FIG. 4 is an illustration of a sample playslip that may be used by a bettor to enter an exemplary wagering game according to a preferred embodiment of the present invention.

FIG. 5 is an illustration of a sample ticket that may be obtained by a bettor as a record of the entry into an exemplary wagering game according to a preferred embodiment of the present invention.

FIG. 6 is a table that illustrates a possible allocation of the wagering pool for an exemplary wagering game according to a preferred embodiment of the present invention.

FIG. 7 is a table that illustrates an example of a wagering pool rollover for an exemplary wagering game according to a preferred embodiment of the present invention.

### DETAILED DESCRIPTION OF THE INVENTION

The present invention provides a system and a method for conducting a wagering game, such as a lottery game or a pari-mutuel wager. In one exemplary embodiment, the present invention is directed to methods of wagering, particularly lottery and pari-mutuel type wagering, wherein the pool (i.e., the combination of wagers placed for a given wagering activity) includes lottery plays or wagers where the lottery players or bettors attempt to correctly select the following: (a) an entry to finish among the first five finishers in the first designated event; (b) an entry to finish among the first four finishers in the second designated event; (c) an entry to finish among the first three finishers in the third designated event; (d) an entry to finish among the first two finishers in the fourth designated event; (e) an entry to finish first in the fifth designated event; and (f) the first seven entries to finish, in exact order, in the sixth and final designated event.

As discussed above, in conventional lottery games and pari-mutuel wagering activities, the size of the jackpot is typically inversely related to the ability of the lottery player or bettor population to predict the outcome of a given event or series of events. Because the predictability of events varies considerably from one event to another, a lottery operator or pari-mutuel venue has little control over the jackpots offered in association with such events. The presently disclosed methods of lottery plays or wagering serve to create substantial jackpots on a more predictable basis due to the large number of permutations that can result based on the number of correct selections that must be made. The increased randomness helps an establishment to operate on a more predictive model since the jackpots are likely to develop due to the decreased likelihood that expert handicappers will be able to predict the outcome of each event. In this manner, although the event outcomes are not randomized in the same way as, for example, a lottery that is specifically designed to create exactly equal probabilities for every possible outcome, the present invention provides a quasi-lottery game in the context of a pari-mutuel wagering framework.

In an exemplary embodiment of the present invention, six events, such as dog or horse races (referred to hereinafter as races for purposes of convenience), may be conducted. Such races may occur in relatively rapid succession and may be run at a plurality of tracks or venues wherein races may be monitored from one track to another through an appropriate network or broadcast system as will be appreciated by those of ordinary skill in the art.

For example, the wagering activity includes six specified races which may have been previously identified by the administrator (such as, for example, a governmental agency) of the lottery or other wagering activity. A lottery player or bettor may pay a specified amount to participate in the lottery game or wagering activity and then select the following, in accordance with his or her predictions or handicapping activities: (a) an entry to finish among the first five finishers in the first designated event; (b) an entry to finish among the first four finishers in the second designated event; (c) an entry to finish among the first three finishers in the third designated event; (d) an entry to finish among the first two finishers in the fourth designated event; (e) an entry to finish first in the fifth designated event; and (f) the first seven entries to finish, in exact order, in the sixth and final designated event.

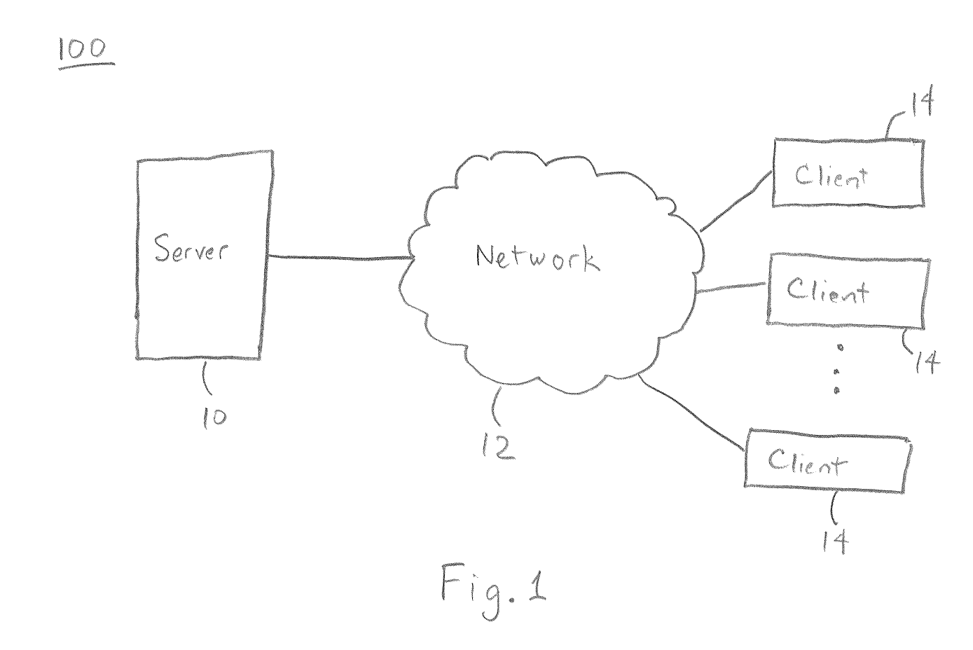

Referring to FIG. 1, according to a preferred embodiment of the invention, the wagering game is typically implemented through the use of a system 100. The system 100 includes a plurality of electronic client devices 14 that are connected to a host server 10 via a network 12. A bettor may use the client device 14 to directly submit a wager entry in order to participate in the wagering game, which is hosted on the host server 10. Alternatively, a bettor may submit a wager entry to a person employed to receive entries, such as a ticket clerk at a horse-racing venue, who then uses the client device 14 to submit the wager entry. The host server 10 receives all such wager entries.

In a typical application, the present invention may be implemented by a governmental agency responsible for lottery administration, such as a lottery board, or by a venue at which race events are conducted, such as a horse racing venue or a dog racing venue. Accordingly, the host server 10 may include one or more totalizator servers, one or more lottery servers, or one or more servers managed by an entity for the dedicated purpose of managing the wagering game. The client device 14 may include a tote terminal or kiosk, as might typically be seen at a racing venue; a lottery terminal; any personal or business computer that has either an application or browser session that communicates with the host server 10; or an account wagering client, such as a browser residing on a personal computer, cellular telephone, personal digital assistant (PDA), or other wireless device that communicates with the host server 10. A kiosk-type client terminal 14 may be used by the bettor at a racing venue to place his/her bet. The kiosk 14 may include a touch sensitive LED display 52, an LCD display 54, a credit card reader 56 (and/or a cash input slot), and a printer 58 to print out receipts that reflect the wagers placed or winning tickets (and/or a cash output slot). The network 12 may include any private or public network, including a local area network (LAN), a wide area network (WAN), the World Wide Web, an Intranet, or the Internet. The network 12 may include wired and/or wireless devices, thus enabling the placement of wagers through the use of a wireless device that is able to connect to the network 12.

The host server 10 is preferably implemented by the use of one or more general purpose computers, such as, for example, a Sun Microsystems F15k. The client device 14 is also preferably implemented by the use of one or more general purpose computers, such as, for example, a typical personal computer manufactured by Dell, Gateway, or Hewlett-Packard. Each of the host server 10 and the client device 14 can include a microprocessor. The microprocessor can be any type of processor, such as, for example, any type of general purpose microprocessor or microcontroller, a digital signal processing (DSP) processor, an application-specific integrated circuit (ASIC), a programmable read-only memory (PROM), or any combination thereof. The host server 10 may use its microprocessor to read a computer-readable medium containing software that includes instructions for carrying out one or more of the functions of the host server 10, as further described below.

Each of the host server 10 and the client device 14 can also include computer memory, such as, for example, random-access memory (RAM). However, the computer memory of each of the host server 10 and the client device 14 can be any type of computer memory or any other type of electronic storage medium that is located either internally or externally to the host server 10 or the client device 14, such as, for example, read-only memory (ROM), compact disc read-only memory (CDROM), electro-optical memory, magneto-optical memory, an erasable programmable read-only memory (EPROM), an electrically-erasable programmable read-only memory (EEPROM), or the like. According to exemplary embodiments, the respective RAM can contain, for example, the operating program for either the host server 10 or the client device 14. As will be appreciated based on the following description, the RAM can, for example, be programmed using conventional techniques known to those having ordinary skill in the art of computer programming. The actual source code or object code for carrying out the steps of, for example, a computer program can be stored in the RAM. Each of the host server 10 and the client device 14 can also include a database. The database can be any type of computer database for storing, maintaining, and allowing access to electronic information stored therein. The host server 10 preferably resides on a network 12, such as a local area network (LAN), a wide area network (WAN), or the Internet. The client device 14 preferably is connected to the network 12 on which the host server 10 resides, thus enabling electronic communications between the host server 10 and the client device 14 over a communications connection, whether locally or remotely, such as, for example, an Ethernet connection, an RS-232 connection, or the like.

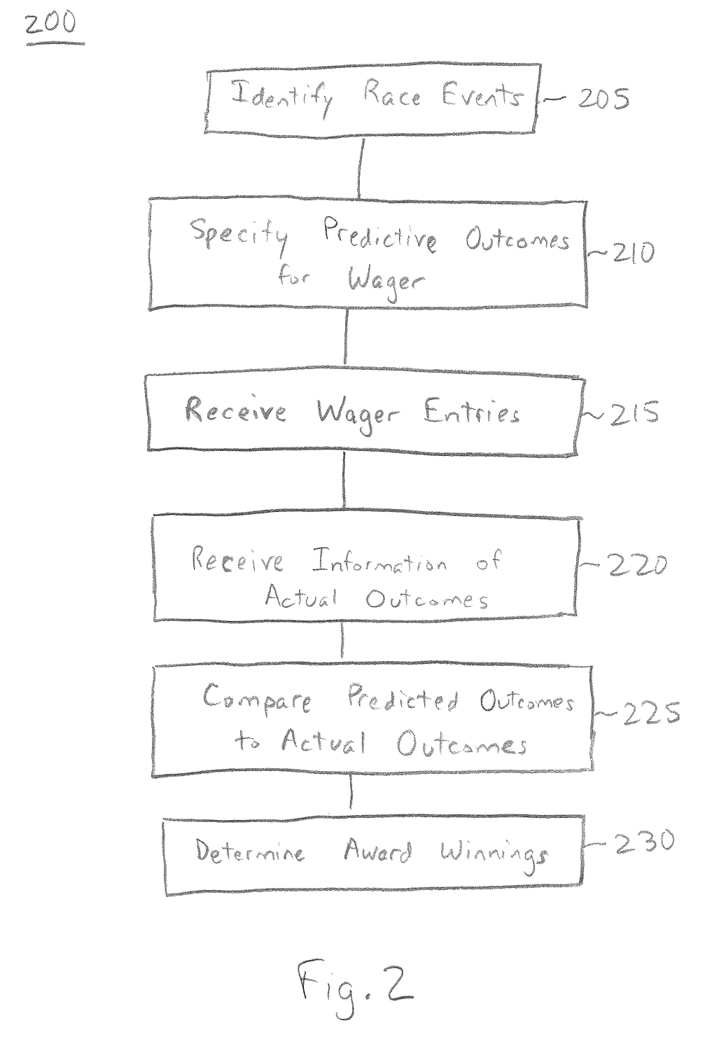

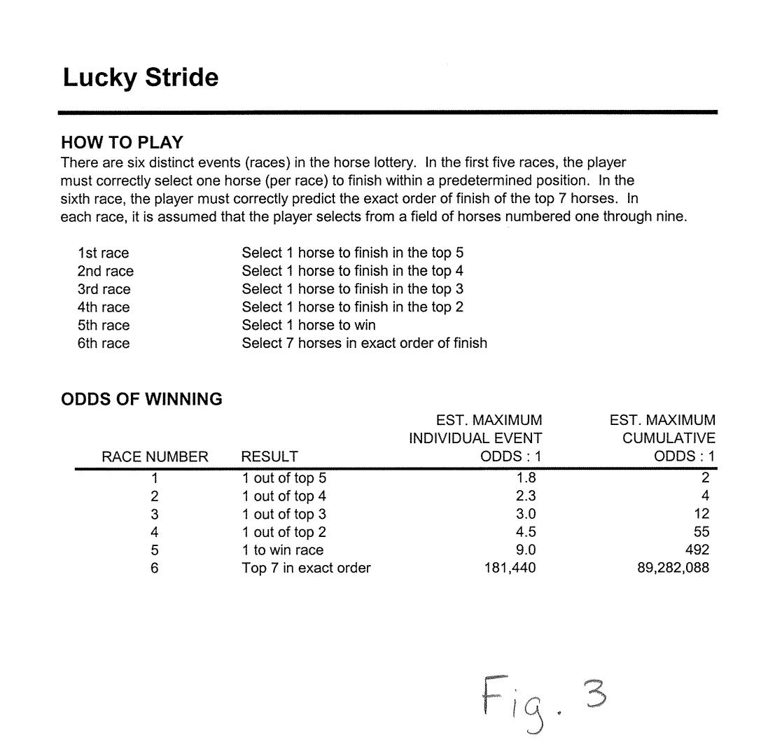

Referring to FIG. 2, a flow chart 200 illustrates an exemplary method for conducting a pari-mutuel wagering game according to a preferred embodiment of the invention. In the first step 205, a set of race events are identified. For example, a set of six horse races may be designated for the wager. In the second step 210, a set of predictive outcomes are specified on a race-by-race basis as the outcomes to be predicted by any bettor wishing to submit an entry for the wagering game. Referring also to FIG. 3, using the same six-race example as described above, an exemplary set of predictive outcomes and the respective maximum odds of winning for each race are shown, as well as the cumulative odds of winning all of the races. The maximum odds shown are based on the assumption that each horse race has exactly nine horses racing in that race, and that each horse has an equal probability of finishing in any given position.

For the present example, the odds of making a correct prediction for all six races, based on an assumed field size of nine horses per race, and further based on the assumption that each horse has an equal chance of finishing in any given place, can be determined. For the first race, in which one of the first five finishers is to be selected, the odds are 9:5, which is the same as 1.8:1. For the second race, in which one of the first four finishers is to be selected, the odds are 9:4, which is the same as 2.25:1; and so the odds of correctly predicting both of the first and second race are 1.8*2.25=4.05:1. Similarly, for the third race, in which one of the first three finishers is to be predicted, the odds are 9:3=3.0:1, and the cumulative odds for correctly predicting the first three races are 4.05*3=12.15:1. For the fourth race, in which one of the first two finishers is to be predicted, the odds are 9:2=4.50:1, and the cumulative odds for correctly predicting the first four races are 12.15*4.50=54.675:1. For the fifth race, in which the winner is to be predicted, the odds are 9:1=9.0:1, and the cumulative odds for correctly predicting the first four races are 54.675*9.0=492.075:1. For the sixth race, the first seven finishers are to be predicted in the correct order. For this type of situation, the formula is n factorial divided by (n−x) factorial, where n is the number of participants, and x is the number of correctly ordered finishers. In the present example, n=9 and x=7, so the formula is 9 factorial divided by 2 factorial (i.e., 9!/2!). Nine factorial is 9×8×7×6×5×4×3×2×1=362,880, and 2!=2×1=2, so 9!/2!=362,880/2=181,440. Thus, the odds of correctly predicting the first seven finishers of the sixth race in the correct order is 181,440:1, and the cumulative odds of making a correct prediction for all six races is 492.075*181,440=89,282,088:1, or approximately 1 in 89 million.

Using the example illustrated in FIG. 3, in the first designated horse race, the requirement may be to select one participating horse that will finish among the first five finishers of that race. In the second designated horse race, it may be specified that the bettor shall predict one horse that will finish among the first four finishers of that race. In the third race, the bettor may be required to predict one of the first three finishers. In the fourth race, the bettor may be required to predict one of the first two finishers. In the fifth race, the bettor may be required to predict the winning horse. Finally, in the sixth race, the bettor may be required to predict the first three, four, five, six, seven, or more finishers in the correct order.

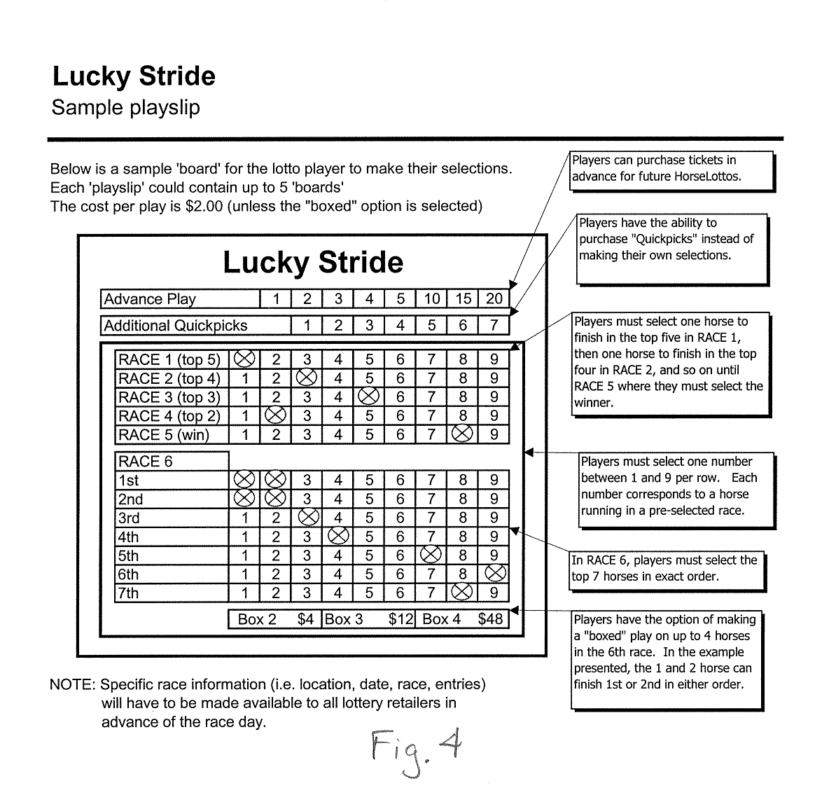

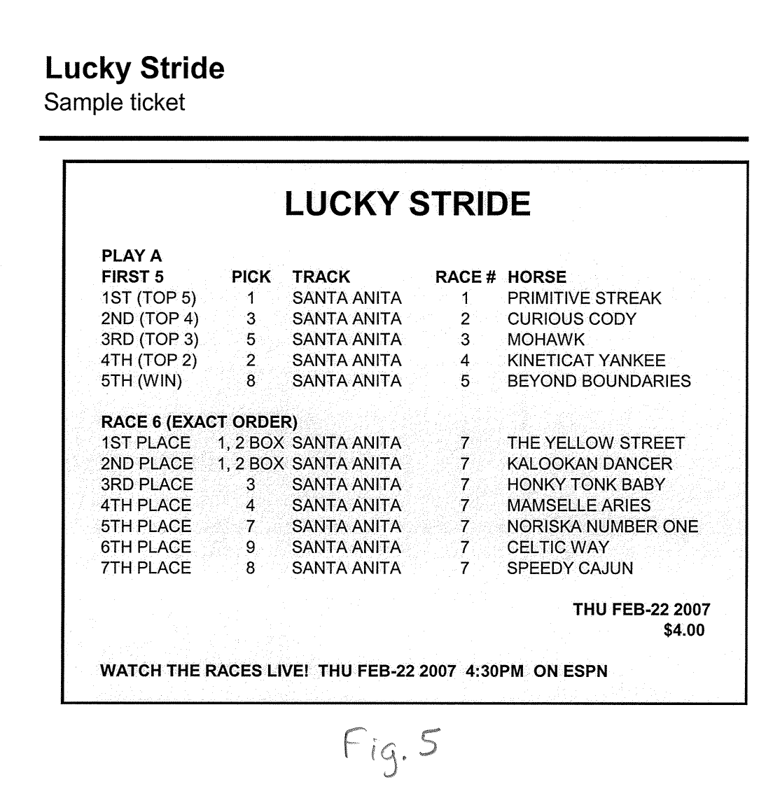

Then, in step 215, the wager entries are received. Referring also to FIG. 4, in a typical embodiment, a bettor may preferably use a playslip to indicate a set of predictions for each designated race event. The playslip is submitted, together with a payment of the cost per play (i.e., $2.00 in the example shown in FIG. 4), to a clerk, who uses the client computer 14 to electronically submit the entry via the network 12 to the host server 10. Alternatively, the bettor or lottery player may directly submit the entry through the use of a client computer 14 that is connected to the host server 10 via the network 12. In this manner, the host server 10 receives all wager entries. Referring also to FIG. 5, after submitting an entry, the bettor or lottery player will preferably receive a ticket that indicates all of the predicted outcomes that were provided with the bettor's wager entry, either in physical form (e.g., a slip of paper) from the clerk, or in electronic form at the client computer 14. To the extent that such a ticket is provided, the ticket serves as proof that the bettor or lottery player actually submitted the particular wager entry having the indicated predictions, similar to a lottery ticket, and therefore may also be redeemable for winnings after the race events are completed. The ticket also serves as a reminder to the bettor of the predictions and also of the races, and may include the time and television channel on which they may be viewed. This information tends to make the game more exciting for the bettor or lottery player, who can then be a more active participant in the wagering game by watching the races on television to follow along and find out immediately whether or not the prediction for each race was correct. Alternatively, a ticket may not be provided to the bettor or lottery player; however, the history of the wager will be stored in an account profile by the host server 10 to ensure that the wager is properly accounted for and that any winnings resulting from the wager will be properly awarded.

At step 220, after each race has actually been run, the race result information is communicated to the host server 10. The race result information includes the actual outcome of each race, including the exact order of finish of all participating horses. Other race result information may include the times of finish, the distances between consecutive finishers, and other race-related data that may be of interest to bettors for future wagering games involving any of those same horses. Then, at step 225, the actual outcome of each race is compared with the predicted outcome of each race on each wager entry. Finally, at step 230, the result of the comparison step is used to determine an allocation of the wagering pool to be awarded to each entrant.

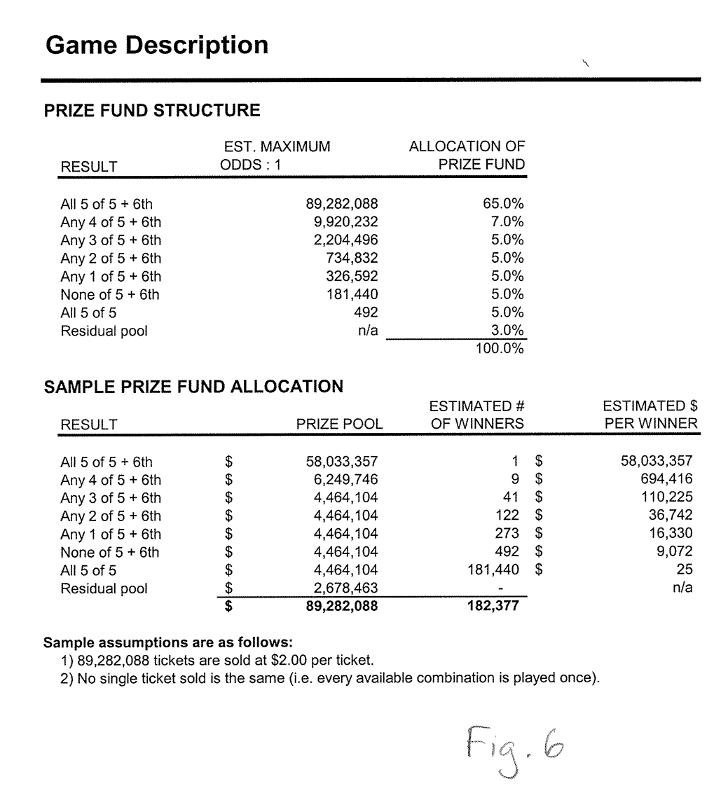

Referring now to FIG. 6, a tiered prize structure is shown which may be used in conjunction with the wagering methods described above, and in particular, with step 230 of FIG. 2. The exemplary prize structure is based on the exemplary assumptions of an average field size (e.g., the average number of runners or participants in the selected events) being nine, a ticket price (or required wager amount) of $2.00 with approximately 89,000,000 individual tickets or wagers being sold, and 50% of the collected monies being distributed as prizes to the wagering game entrants. In the example illustrated in FIG. 6, 65% of the total prize money is to be allocated to the top tier jackpot, and smaller amounts are allocated to lower prize tiers. For example, entries for which the top seven finishers in the sixth race are correctly predicted in their exact order, and in which four of the first five races have correct predictions, would be allocated approximately 7.0% of the prize pool; each such entry would receive an equal share of that allocation. Entries for which the top seven finishers in the sixth race are correctly predicted in their exact order, and in which three of the first five races have correct predictions, would be allocated approximately 5.0% of the prize pool; each such entry would receive an equal share of that allocation. As indicated in FIG. 6, entries for which the top seven finishers in the sixth race are correctly predicted in their exact order, and in which two, one, or zero of the first five races have correct predictions, would be allocated approximately 5.0%, 5.0%, or 5.0% of the prize pool, respectively. Entries for which the sixth race prediction is not correct, but the predictions for all five of the other races are correct, would be allocated approximately 5.0% of the pool; each such entry would receive an equal share of that allocation. Other entries, such as those for which the sixth race prediction is incorrect and at least one of the other five races has an incorrect prediction, would receive an allocation of zero. The foregoing allocations are offered for example purposes only. The number of prize tiers and the amount allocated to each prize tier can vary widely.

A residual pool may be provided to enable consolation prizes to be awarded for certain situations, at the discretion of the administrator of the wagering game. Referring to FIG. 6, in one exemplary embodiment, 3.0% of the prize pool may be allocated to the residual pool. For example, occasionally a horse that was scheduled to participate in a given race may be scratched from the race. If such a scratch occurs while wagering is still open, preferably no more wagers that include the scratched horse as part of the prediction will be accepted, and any bettor who has previously placed a wager that includes one or more scratched betting interests among his selections may elect to cancel the wager and receive a refund. However, a late scratch may occur after the close of wagering. Particularly in that situation, an entry that includes a prediction involving the scratched horse may be made eligible to receive a consolation prize from the residual pool. Alternatively, such a scratch may be treated in several other ways. For example, any prediction involving a scratched horse may be automatically deemed an incorrect prediction, or, alternatively, such a prediction may be automatically deemed as being a correct prediction. In another alternative embodiment, the prediction involving the scratched horse may be automatically replaced by a substitute horse (i.e., one of the horses that is participating in the race but that had not previously been included in the prediction) selected by the administrator of the wagering game. In addition, other anomalous situations may arise for which consolation prizes are awarded from the residual pool. For example, an entire race that was designated for the wager may be cancelled. In such an instance, the administrator may treat the entire race as a scratch, and the prizes may be adjusted at the discretion of the administrator, possibly including consolation prize awards from the residual pool. Alternatively, where an entire race has been cancelled, or in other unforeseen circumstances, the wagers may be refunded.

Another example of an anomalous situation is a dead heat. For example, if two horses finish in an exact tie for first place in a race, a dead heat may be declared. If a dead heat occurs, both horses may be considered to be equally correct predictions for the respective place in the order of finish. In one embodiment, a prediction of either horse involved in the dead heat is considered a correct prediction for the respective place in the order of finish, but neither is considered a correct prediction for the next place in the order of finish. As an example of this embodiment, let us suppose that horse #5 and horse #9 finish in a dead heat, tied for first place, followed by horse #6, then horse #2, and then horse #8. In this embodiment, for this example, a superfecta prediction of 5-6-2-8 would be deemed correct and a superfecta prediction of 9-6-2-8 would be deemed correct, but a prediction of 5-9-6-2 would be deemed incorrect, and a prediction of 9-5-6-2 would be deemed incorrect. In an alternative embodiment, the 5-9-6-2 and 9-5-6-2 predictions may be deemed correct, in recognition of both the dead heat and the fact that these two predictions correctly identify the first four horses to finish the race. Because of the unusual nature of this type of situation, a consolation prize may also be awarded from the residual pool for appropriate entries that are affected by the dead heat. Such a determination is to be made at the discretion of the administrator of the wagering game.

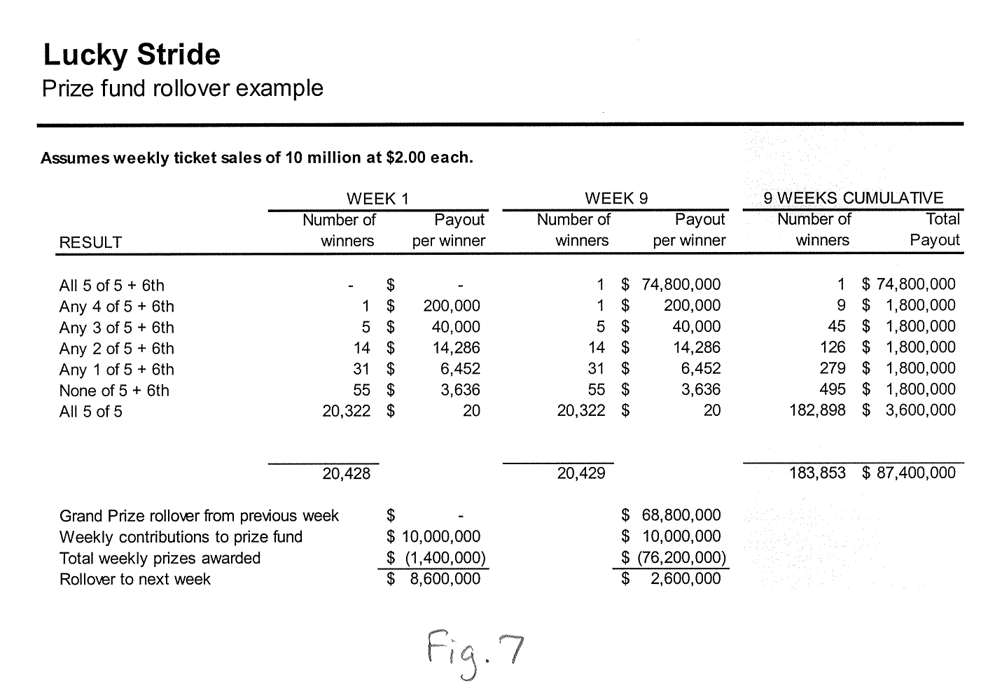

Referring to FIG. 7, in situations where the jackpot of a given tier is not won, the jackpot may be carried over into, for example, another wagering activity, such as the next iteration of the wagering game. For example, as illustrated in FIG. 7, for the first eight weeks of a weekly wagering game according to a preferred embodiment of the present invention, there may be no jackpot winners, thus enabling $8.6 million per week to be rolled over. Then, in the ninth week, there may be a winner of the jackpot, who therefore is awarded the entire rollover of $68.8 million, plus that week's allocation of $8.6 million, for a total payout of $74.8 million. In another embodiment, particularly in the pari-mutuel wagering context, jackpots not won (i.e., in any tier, not just the highest tier) may be rolled down to one or more designated lower tier levels and distributed, for example, pari-mutuelly, thereby providing an unanticipated bonus to participants with winning wagers in such designated lower tiers. In yet another embodiment, particularly in the pari-mutuel wagering context, jackpots not won (i.e., in any tier other than the highest tier) may be rolled up to one or more designated higher tier levels and distributed, for example, pari-mutuelly, thereby providing an unanticipated bonus to participants with winning wagers in such designated higher tiers.

In an alternative embodiment, the wagering game of the present invention may involve the use of one or more historical races in lieu of races that have not yet occurred during the open wagering period. In other aspects, the wager would be structured similarly as described above for the other embodiments of the invention; i.e., a wager entry would include a “prediction” corresponding to a specified “predictive” outcome of the results of the historical race. Although the actual race results have already been determined prior to the act of making such a “prediction”, the bettor making the prediction presumably does not know those actual results; therefore, the prediction functions in the same manner as it would if the actual race results had not been determined in advance. When historical races are to be used, care must be taken to minimize the likelihood that a potential bettor may be able to learn the results of the historical race prior to placing a wager. Accordingly, in a typical implementation, a large database of historical races is used (e.g., tens of thousands of historical races may be included in the database), and a random selection of one or more races is made in order to effectively randomize the identification of the historical race. In addition, other steps may be taken, such as, for example, selective notification of race-specific information that could be used to enable a bettor to ascertain the results in advance of the placement of the wager. Accordingly, although a historical race is being used, the choice of which historical race and the selective notification of race-specific information serves the purpose of effectively randomizing the possible outcomes to an even greater degree. In this manner, according to the presently-described embodiment of the invention, the use of historical races may further serve as a quasi-lottery game by virtue of this randomization.

Thus, what has been described is a method and system for conducting lottery-style pari-mutuel wagering, which is attractive to many bettors, provides for increased jackpots, is easy to understand by the typical bettor, and provides multiple tiers of prizes.

While the present invention has been described with respect to what is presently considered to be the preferred embodiment, it is to be understood that the invention is not limited to the disclosed embodiments. To the contrary, the invention is intended to cover various modifications and equivalent arrangements included within the spirit and scope of the appended claims. For example, variables, such as the percentage of collected monies distributed into the prize pool, jackpot allocation, average field size, number of tiers and other variables, may be altered, and different prize structures may be utilized. In addition, race events other than horse races may be used. The number of races may be varied. Historical race events may be employed. The specification of the predictive outcomes to be used for each wager entry may be varied. For example, instead of predicting the first seven finishers in the exact order, a prediction of the first six finishers in the correct order may be specified, or any number of finishers in the correct order may be specified; or, a number of finishers in an incorrect order may be specified. Similarly, instead of predicting one of the first one, two, three, four, or five finishers in a given race, a prediction of the last-place finisher may be specified for a particular race, or any other such possible outcome. Using such variables, one of ordinary skill in the art may compute the various odds of winning a specified wagering event and provide a corresponding prize structure. It is further noted that the above exemplary embodiments readily provide scalability. Thus, the present method may be tailored to individual venues depending, for example, on the number of patrons attending a given event and the expected level of participation by the patrons in the wagering activity. The scope of the following claims is to be accorded the broadest interpretation so as to encompass all such modifications and equivalent structures and functions.

Two appendices to this specification are attached. Appendix A includes an exemplary set of proposed regulations that could be used in conjunction with an administration of a lottery game according to a preferred embodiment of the invention. Appendix B includes an exemplary set of proposed regulations that could be used in conjunction with an administration of a pari-mutuel wagering game according to a preferred embodiment of the invention. The entire contents of both of Appendix A and Appendix B are incorporated by reference herein.

All U.S. patent documents discussed above are hereby incorporated by reference into the Detailed Description of the Invention.

### Appendix A

### Proposed Lottery Regulation for “Lucky Stride” Game

### 3. Method of Play

The following subsections specify how a player shall make his/her selection(s) in LUCKY STRIDE:

a. Selection Cost
Each LUCKY STRIDE selection shall sell for two dollars ($2.00) per play per draw. LUCKY STRIDE tickets may be purchased only through [Applicable Lottery Commission] authorized retailers.

b. Play Selections
(1) A player must mark his/her horse numbers on a LUCKY STRIDE playslip for input into a terminal. A player shall mark the LUCKY STRIDE playslip as follows:
   (a) First, a player shall either mark the horse numbers in the position the horses will finish in each of the LUCKY STRIDE races, or mark Quick Pick to have the [Applicable Lottery Commission] computer make the horse number selections.
   (b) A player may choose to provide for alternative outcomes for one or more selected horses by selecting the “box” option at the bottom of the ticket.
      (i) By selecting the “box” option in respect of the specifically selected horses, either horse may finish in the order of finish indicated on the playslip.
      (ii) Example: If a player selects the “box” option in respect of horse numbers 2 and 3 to finish first and second in the sixth Lucky Stride race, the player's selection regarding this order of finish will be deemed correct if the actual order of finish is either 2/3/ . . . or 3/2/ . . . .
   (c) If the player does not mark the number of draws, one (1) draw will automatically be selected and it will be for the next scheduled draw. A player may wager 2, 3, 4, 5, 7 and 20 consecutive draws on the same ticket.
(2) A player may also verbally direct a retailer to activate the Quick Pick selection process on the terminal to produce a ticket containing a randomly generated LUCKY STRIDE play selection.
(3) The [Applicable Lottery Commission] has installed different types of terminals at retailer locations which at the exclusive discretion of the [Applicable Lottery Commission] have been determined appropriate to the retailer location. Therefore, after the player has marked the playslip, the ticket may be obtained depending on the retailer location, by either submitting the completed playslip to the retailer for processing on a terminal or by personally processing the playslip on a self-serve terminal (SST). A single ticket will contain only one play selection, except in cases when a player has selected one or more of the “box” options offered on the bottom of the playslip. In this case, the ticket will display all of the play selections available to the player based on the number of items he/she chose to box.
(4) A valid original LUCKY STRIDE ticket shall be the only proof of a player's play selections and shall be the only valid evidence of eligibility for a prize or promotional award. A playslip shall have no pecuniary or prize value and shall not constitute evidence of purchase of the play selection(s) or of the particular horse numbers, horse positions.

c. Entry Into the Drawing
(1) Each valid play selection made during the drawing period shall be placed into the LUCKY STRIDE play pool for which the ticket was purchased.
(2) When using the Advance Play feature, a valid LUCKY STRIDE play selection made for each consecutive draw period shall be placed into each LUCKY STRIDE pool designated.
(3) The [Applicable Lottery Commission] shall determine when entries for a given Lucky Stride draw will close.

d. Canceling a Ticket
(1) Except in a case involving a scratched horse or cancelled race under §§ 6.d or 6.3, a ticket for a single draw or a ticket using the Advance Play feature may be cancelled by returning the ticket to the original selling retailer, on the same day it was purchased, prior to pool closure. The effect of canceling a ticket is to void the ticket and remove it from the pool of tickets eligible for that draw. If an authorized [Applicable Lottery Commission] retailer cancels a ticket, the [Applicable Lottery Commission] shall not be obligated to pay any prize or promotional award to the holder of that ticket whether or not the ticket was cancelled in error. The retailer is prohibited from canceling a ticket unless the player returns the original ticket to the selling retailer.
(2) If a ticket is cancelled in accordance with the provisions of this section, the terminal will issue a cancellation authorization receipt, and the player shall be entitled to a refund from the retailer equal to the purchase price of the ticket.
(3) In the event a horse is deemed scratched due to a cancelled race or in the event a player selects a horse that actually is scratched from a race, each player selecting the scratched horse or horses may cancel his or her ticket and seeking a refund pursuant to this §3.d, provided that request to cancel the ticket and seek a refund is made before wagering on the particular Lucky Stride game is officially closed. If a request to cancel a ticket or seek a refund is made after wagering on the particular Lucky Stride game officially closes, such ticket may not be cancelled or receive a refund, and it will remain in the ticket pool with the tickets.

e. Responsibility for Ticket Accuracy and Handling
1. The player is solely responsible for the accuracy of the player's play selection(s) and other data printed on the ticket. The [Applicable Lottery Commission] shall not be responsible for tickets printed in error or any erroneous information on the ticket. The player's sole recourse is limited to cancellation of the erroneous ticket pursuant to these regulations.
2. The [Applicable Lottery Commission] shall not be responsible for lost or stolen tickets. Any stolen ticket, upon substantiation of its status as stolen, shall be deemed void and ineligible for any prize.
3. Players are solely responsible for ascertaining whether they have won a prize and for claiming their prize subject to verification by the [Applicable Lottery Commission].
4. The [Applicable Lottery Commission] shall not be responsible for tickets mailed or delivered to any address other than that designated by the [Applicable Lottery Commission] for such purpose or which are delivered late, damaged, incomplete, or for postage-due mail, or for claims not submitted and received within the claim period.

### 4. Determination of Prize Winners

a. Prize Determination Procedures
Prize determinations of LUCKY STRIDE winners shall be held weekly on Sundays or such other day as the [Applicable Lottery Commission] and [host racing association] jointly may determine, pursuant to the methods, policies, and procedures prescribed in writing by the [Applicable Lottery Director] prior to the prize determinations. The time, place and day of such prize determinations may be changed at the discretion of the [Applicable Lottery Director]. Prize determinations shall be open to the public. Race selection and prize determination procedures are confidential to ensure the security, integrity, honesty, and fairness of the prize determinations.

b. Determination of Winning Selections for Lucky Stride
The objective of the game is to utilize live horses races conducted at a racetrack licensed by the applicable regulatory authority responsible for regulating horse racing in that state, province or country to select the following outcomes of six horse races selected by the [Applicable Lottery Commission]:
   (1) One horse to finish among any of the first five horses to finish in the first LUCKY STRIDE race after the results of the race are declared to be official;
   (2) One horse to finish among any of the first four horses to finish in the second LUCKY STRIDE race after the results of that race are declared to be official;
   (3) One horse to finish among any of the first three horses to finish in the third LUCKY STRIDE race after the results of that race are declared to be official;
   (4) One horse to finish among any of the first two horses to finish in the fourth LUCKY STRIDE race after the results of that race are declared to be official;
   (5) One horse to finish first in the fifth LUCKY STRIDE race after the results of that race are declared to be official; and
   (6) Each of the horses to finish first, second, third, fourth, fifth, sixth and seventh, in exact order, in the sixth LUCKY STRIDE race after the results of that race are declared to be official.
Holders of valid winning tickets for a given drawing bearing the horse numbers correctly selected to each position required to qualify for a share of a particular LUCKY STRIDE pool may be entitled to a prize or promotional award in accordance with these regulations.

c. Determination of Valid Claims
(1) In all cases, the determination of prize or promotional award winners shall be subject to the provisions of the [Applicable Lottery Act], these regulations, official promotion rules, and any requirements set out on the playslip or in play brochures.
(2) A ticket is a bearer instrument until signed on the back by the ticket holder.

d. More than One (1) Winner for a Lucky Stride Prize Category
If more than one (1) LUCKY STRIDE play selection is successful in matching the winning horses in any of the various prize categories shall share equally the respective LUCKY STRIDE poll(s) for the prize category at issue.

e. No More than One (1) Prize for a Single Winning Horse Selection
Players are eligible to receive, subject to the validation requirements of these regulations, only the highest category prize or promotional award for each winning play selection. For example, a player who correctly selects the position of his/her selected horses in each the first five LUCKY STRIDE races and correctly selects all seven finishers, in exact order, in the sixth LUCKY STRIDE race will receive the prize for that prize level only and will not also receive the prize associated with a lesser number of correct selections.

### 5. Odds and Prizes

a. Prize Pool
The available LUCKY STRIDE prize pool will be approximately fifty percent (50%) of total sales for the LUCKY STRIDE game period immediately preceding pool closure. The available prize pool includes sales for Advance Play tickets purchased in prior LUCKY STRIDE game draw periods for the draw. Prize pool allocations for the separate categories shall be apportioned as set forth below.

b. Estimated Odds of Winning Prizes and Prize Pool Allocations [(Based on 9 Horses Per Race)]

| | | | Percent | |
|---|---|---|---|---|
| | | | of | Estimated |
| | Prize Fund | | Prize | Maximum |
| | Category | Prize Combinations | Pool | Odds |
| 1. | Lucky Stride | Correctly identify first seven horses, in exact | 65.0% | 1:89,282,088 |
| | Grand Prize | order, in sixth LUCKY STRIDE race and the | | |
| | | required position in each of the first five | | |
| | | LUCKY STRIDE races | | |
| 2. | Lucky Stride A | Correctly identify first seven horses, in exact | 7.0% | 1:9,920,232 |
| | | order, in sixth LUCKY STRIDE race and the | | |
| | | required position in any four of first five | | |
| | | LUCKY STRIDE races | | |
| 3. | Lucky Stride B | Correctly identify first seven horses, in exact | 5.0% | 1:2,204,496 |
| | | order, in sixth LUCKY STRIDE race and the | | |
| | | required position in any three of first five | | |
| | | LUCKY STRIDE races | | |
| 4. | Lucky Stride C | Correctly identify first seven horses, in exact | 5.0% | 1:734,832 |
| | | order, in sixth LUCKY STRIDE race and the | | |
| | | required position in any two of first five | | |
| | | LUCKY STRIDE races | | |
| 5. | Lucky Stride D | Correctly identify first seven horses, in exact | 5.0% | 1:326,592 |
| | | order, in sixth LUCKY STRIDE race and the | | |
| | | required position in any one of first five | | |
| | | LUCKY STRIDE races | | |
| 6. | Lucky Stride E | Correctly identify first seven horses, in exact | 5.0% | 1:181,440 |
| | | order, in sixth LUCKY STRIDE race and no | | |
| | | correct selections in any of the first five | | |
| | | LUCKY STRIDE races | | |
| 7. | Lucky Stride F | Correctly select the required position in each | 5.0% | 1:492 |
| | | of the first five LUCKY STRIDE races only | | |
| 8. | Consolation | Residual pool for consolation payouts | 3.0% | |
| | Pool | | | |

c. Pool Amount for Prize Categories for Lucky Stride Game
All LUCKY STRIDE prize categories shall be paid on a pari-mutuel basis with each winning play selection in each prize category considered to be a single unit equal to one share of that prize category.

d. Amount of Shared Prize

Notwithstanding the allocations provided herein, shares in each prize category shall be rounded down to the nearest dollar ($1.00) from the calculated amount; except in those cases where the share value is calculated at $1.99 or less, in which case the share shall be rounded up to $2.00. For LUCKY STRIDE, all prize pool money which is left over after paying out the prizes that are rounded down shall remain in the prize pool and will be added to the Grand Prize category prize pool amount for that drawing after the category apportionments specified in these regulations have been made.

e. Rollover in Absence of Winner
In respect of each LUCKY STRIDE prize category (e.g., Lucky Stride Grand Prize, Lucky Stride A, Lucky Stride B, etc.), if there is no valid winning ticket for a given drawing, all monies allocated for that prize category shall be carried forward or “rolled over” to that same prize category for the next subsequent drawing and added to the amounts allocated to that prize category, pursuant to this §5, from the purchase of additional LUCKY STRIDE tickets [for the next subsequent drawing].

f. Value and Payment of Pari-Mutuel Prizes
The prizes in the LUCKY STRIDE prize categories shall consist of the cash amounts contained in the prize pool for each prize category at the time of the draw. Payments of such prizes shall be made to the winner(s) in a single cash payment.

g. Payment to Natural Person

Prize winnings shall be paid to only one natural person and pursuant to established procedures for payment.

h. Withholdings and Offsets

All prizes or promotional awards shall be subject to tax withholdings and offsets as provided by law.

### 6. Miscellaneous

a. Field Entries are Prohibited in any of the Six Designated Lucky Stride Races.

b. Coupled Entries
(1) Coupled entries may be permitted in any of the six designated Lucky Stride races.
(2) Horses comprising a coupled entry shall be considered part of a single betting interest for the purposes of price calculations and distribution of the net Lucky Stride pool.
(3) If a horse in a coupled entry is officially withdrawn or scratched, the remaining horse, or horses, in the coupled entry shall remain as a valid betting interest.
(4) If all horses in a coupled entry are scratched, the provisions of §6.d shall apply.
(5) (i) For the purposes of price calculations only, coupled entries shall be calculated as a single finishing horse, using the finishing position of the leading horse in the coupled entry to determine the order of placing.
   (ii) Example: If the actual order of finish in a race is 1/2/1A/3/4/etc., then the finishers used for that race in the Lucky Stride would be 1/2/3/4/ . . . .

c. Dead Heats
If a dead heat, or dead heats, occur in any of the races designated as the Lucky Stride:
(1) A horse in a dead heat shall be considered as finishing in the position for which it dead heated;
(2) Any selection in a Lucky Stride wager that correctly selects a horse in a dead heat as finishing in the position for which the horse dead heated shall be treated as a correct selection.
(3) Example: If the actual order of finish in a race is 1, 2 (dead heat)/3/4, etc., then players choosing either 1/3/4/ . . . or 2/3/4 . . . shall be eligible for the given designated share of the Net Lucky Stride pool.

d. Scratches
(1) If a horse (or, in the case of a coupled entry, the horses comprising such coupled entry) is scratched in a designated race of the Lucky Stride while wagering on the Lucky Stride is still open:
   (i) No more tickets wagers shall be issued on playslips that select the scratched horse or entire coupled entry; and
   (ii) Any players who previously received a Lucky Stride ticket that includes one or more scratched horses or entire coupled entries may, until the Lucky Stride pool is closed, cancel their ticket and request a refund pursuant to §3.d.
(2) After the Lucky Stride pool has been closed:
   (i) Any horse or entire coupled entry that is scratched in its entirety shall be treated as an incorrect selection; and
   (ii) Other correctly selected finishers on a Lucky Stride ticket shall continue to count toward a player's eligibility to win.
   (iii) Any player selecting a horse or entire coupled entry that is scratched may be eligible to receive a consolation payment pursuant to §6.f.
(3) If, due to a scratch, the number of horses or coupled entries in any one of the Lucky Stride races falls below eight, the race shall be declared a “no contest,” and the effect of this declaration shall be governed by §6.e.

e. Cancellations
(1) If any one of the first five Lucky Stride races are cancelled or declared “no contest” at any time before the Lucky Stride draw pool is closed, all Lucky Stride tickets issued in connection with such Lucky Stride drawing may be refunded pursuant to §3.d.
(2) If the sixth Lucky Stride race or any two or more of the first five Lucky Stride races are cancelled or declared “no contest” at any time before or after the Lucky Stride draw pool is closed, the [Applicable Lottery Commission] shall cancel the Lucky Stride game for that [period] and, upon the request of any player pursuant to §3.d, cancel and refund any tickets that were purchased for that particular drawing.
(3) If no more than one of the first five Lucky Stride races is cancelled or declared “no contest” after Lucky Stride wagering is closed, then:
   (i) For purposes of determining the number of correct selections, each selection made in a Lucky Stride race that is cancelled or declared “no contest” shall be considered to be a scratched entry and handled according to §6.e(3)(iii) below;
   (ii) If, after applying §6.d or §6.e of this regulation, it remains possible for a player to qualify for any share of the Net Lucky Stride pool, such share shall be paid as a single price pool to each of the players, per capita, correctly selecting the number of finishers required to qualify for such share
   (iii) If any player qualifying for a minor share of the Net Lucky Stride pool has one or more selections that have been deemed scratched pursuant to §6.d or §6.e of this regulation, such player shall be entitled to receive a consolation payment as determined in §6.f.
   (iv) If, after applying §6.d or §6.e of this regulation, it becomes impossible for a player to correctly select all of the finishers, in exact order, required to qualify for any given share of the Net Lucky Stride pool, such pool will be rolled over pursuant to §5.e of this regulation.

f. Consolation Payments
(1) Consolation payments shall be determined from the Consolation Pool of the Net Lucky Stride pool and shall be calculated as follows:
   (i). The Consolation Pool shall be divided among the various minor pools, pro rata, according to the relative proportion that each minor pool bears to the total amount of the Net Lucky Stride pool allocated to all minor pools.
   (ii) Consolation payments for players sharing in each minor pool shall be divided equally among all players who qualify for the specific minor pool and who also qualify for a consolation payment.
(2) In respect of each minor share, if no player qualifies for a consolation payment, such portion of the Consolation Pool shall be rolled over and added to the major pool for distribution to any player or players who later qualify to receive the major share.

### Appendix B

### Proposed Pari-Mutuel Regulation for “Lucky Stride” Wager

### 5-4-3-2-1 With Additional Position 7

A. In this regulation, the following words have the meanings indicated.
   (1) “Racing association” means the racing association in the appropriate state, province or country hosting and conducting Lucky Stride wagering.
   (2) “Net Lucky Stride pool” means the total amount wagered in the Lucky Stride pool, to the exclusion of any carryover generated from previous Lucky Stride wagering, less the appropriate take-out.
   (3) “Single price pool” means the method of determining a pay-off price where the aggregate winning tickets are divided into all, or a designated percentage, of the Net Lucky Stride pool, with each winning ticket having the same pay-off price per unit wager.
B. The Lucky Stride is a type of pari-mutuel wager that covers six consecutive races in which a bettor selects one betting interest to officially finish among any of the first five betting interests to finish in the first selected race, then one betting interest to officially finish among any of the first four betting interests to finish in the second selected race, then one betting interest to officially finish among any of the first three betting interests to finish in the third selected race, then one betting interest to officially finish among any of the first two betting interests to finish in the fourth selected race, then one betting interest to officially finish first in the fifth selected race. Finally, the bettor must correctly select each of the betting interests to officially finish first, second, third, fourth, fifth, sixth and seventh, in exact order, in the sixth selected race.
C. The six races which comprise the Lucky Stride:
   (1) Shall be designated by the racing association hosting the wager;
   (2) Shall be clearly designated in the program; and
   (3) May originate from one or more race tracks.
D. The Lucky Stride pool shall be held entirely separate from all other pari-mutuel pools.
E. Subject to appropriate regulatory approval, the racing association hosting the Lucky Stride wager shall establish the minimum amount for a bet on the Lucky Stride.
F. Lucky Stride tickets shall be clearly identified, so as to distinguish them from tickets for other types of pari-mutuel wagers.
G. (1) Subject to appropriate regulatory approval, the racing association hosting the Lucky Stride wager shall designate a major share of the Net Lucky Stride pool, as described in §H of this regulation, and, in addition, may designate one or more of the following:
   (a) A principal minor share of the Net Lucky Stride pool, as described in §I of this regulation; and
   (b) One, or more, additional minor shares of the Net Lucky Stride pool as described in §J of this regulation; and
   (c) a residual share to be used for purposes of funding consolation payments to bettors who are entitled to receive a consolation payment under §S or §T of this regulation.
   (2) Subject to appropriate regulatory approval, the racing association hosting the Lucky Stride wager shall determine the distribution of the Net Lucky Stride pool by designating:
      (a) The minimum number of correct selections, or range of selections, of the finishers, in exact position, as the case may be, in the Lucky Stride races which qualify for the major share and each minor share (including the principal minor share) of the Net Lucky Stride Pool; and
      (b) The percentage of the Net Lucky Stride pool for distribution of each of the shares, including the residual share, designated by the racing association under §G(1) of this regulation.
   (3) The racing association hosting the wager shall publish the following in the program for live racing on which Lucky Stride pari-mutuel wagering is conducted:
      (a) Each designation made by a racing association under §G(1) of this regulation; and
      (b) Each determination made by the racing association under §G(2) of this regulation.
   (4) The racing association may change one or more of its designations or determinations made under either §G(1) or §G(2) of this regulation; however, the change shall not be effective until:
      (a) There has been a mandatory distribution made under §U of this regulation; and
      (b) There is a publication of the change in the next program for live racing on which Lucky Stride wagering is conducted.
H. The major share of the Net Lucky Stride pool, plus any Lucky Stride pool carryover, shall be distributed, as a single price pool, to those bettors who correctly select:
   (1) The correct finisher or finishers in the exact position required in each of the Lucky Stride races; or
   (2) A lesser specified number of finishers in the exact position required in each of the Lucky Stride races.
I. (1) A principal minor share of the Net Lucky Stride pool, if designated, shall be distributed, as a single price pool, to those bettors who correctly select each of the finishers, in exact position, in any four of the first five Lucky Stride races and each of the first seven finishers, in exact position, in the sixth Lucky Stride race
   (2) In designating the principal minor share, the racing association may declare a minimum number of correct selections that must be made in order for bettors to be eligible to receive the principal minor share.
J. A second minor share of the Net Lucky Stride pool, if designated, shall be distributed, as a single price pool, to those bettors who correctly select horses to officially finish within the correct order of finish for any three of the first five Lucky Stride races and each of the first seven finishers, in exact position, in the sixth Lucky Stride race, which is less than the number of correct selections qualifying for the major share of the Net Lucky Stride pool.
K. A third minor share of the Net Lucky Stride pool, if designated, shall be distributed, as a single price pool, to those bettors who correctly select horses to officially finish within the correct order of finish required for any two of the first five Lucky Stride races and each of the first seven finishers, in exact position, in the sixth Lucky Stride race, which is less than the number of correct selections qualifying for the major share of the Net Lucky Stride pool.
L. A fourth minor share of the Net Lucky Stride pool, if designated, shall be distributed, as a single price pool, to those bettors who correctly select horses to officially finish within the correct order of finish required for any four of the first five Lucky Stride races and each of the first seven finishers, in exact position, in the sixth Lucky Stride race, which is less than the number of correct selections qualifying for the major share of the Net Lucky Stride pool.
M. (1) Those bettors qualifying for a major share of the Net Lucky Stride pool do not qualify for any of the principal minor share of the Net Lucky Stride pool or any additional minor shares of the Net Lucky Stride pool.
   (2) Those bettors qualifying for the principal minor share of the Net Lucky Stride pool do not qualify for any additional minor shares of the Net Lucky Stride pool.
   (3) Those bettors qualifying for any one of the other minor shares of the Net Lucky Stride pool do not qualify for any additional minor shares of the Net Lucky Stride pool.
N. Except as provided in §T and §U of this regulation:
   (1) If there are no wagers qualifying for the major share or any minor share of the Net Lucky Stride pool, such share shall be carried over and added to such share of the Net Lucky Stride pool on the next live racing program of the race meeting on which Lucky Stride wagering is conducted.
   (2) If there are no wagers qualifying for a consolation payment under §U of this regulation, the residual share shall be carried over and added to the major share of the Net Lucky Stride pool
O. Fields are prohibited in any of the four designated Lucky Stride races.
P. Coupled entries
   (1) Coupled entries may be permitted in any of the six designated Lucky Stride races.
   (2) Horses comprising a coupled entry shall be considered part of a single betting interest for the purposes of price calculations and distribution of the Net Lucky Stride pool.
   (3) If a horse in a coupled entry is officially withdrawn or scratched, the remaining horse, or horses, in the coupled entry shall remain as a valid betting interest.
   (4) If all horses in a coupled entry are scratched, the provisions of §S of this regulation shall apply.
   (5) (a) For the purposes of price calculations only, coupled entries shall be calculated as a single finishing horse, using the finishing position of the leading horse in the coupled entry to determine the order of placing.
      (b) Example: If the actual order of finish in a race is 1/2/1A/3/4, then the finishers used for that race in the Lucky Stride would be 1/2/3/4.
Q. Dead heats
   If a dead heat, or dead heats, occur in any of the races designated as the Lucky Stride:
   (1) A horse in a dead heat shall be considered as finishing in the position for which it dead heated;
   (2) Any selection in a Lucky Stride wager that correctly selects a horse in a dead heat as finishing in the position for which the horse dead heated shall be treated as a correct selection.
   (3) Example: If the actual order of finish in a race is 1, 2 (dead heat)/3/4/etc., then bettors choosing either 1/3/4/ . . . or 2/3/4/ . . . shall be eligible for the given designated share of the Net Lucky Stride pool
R. Wagering for the Lucky Stride shall close at the same time that wagering is closed on the first designated race of the Lucky Stride races or at such other time that the racing association hosting the wagering or such racing association's applicable regulatory agency.
S. Scratches
   (1) If an entire betting interest is scratched in a designated race of the Lucky Stride while wagering on the Lucky Stride is still open:
      (a) No more wagers shall be accepted selecting that betting interest; and
      (b) Any wager that includes one or more scratched betting interests shall be void entitling the bettor to seek and receive a refund.
   (2) After Lucky Stride wagering is closed (i.e., a “late scratch”):
      (a) Any betting interest that is scratched in its entirety shall be treated as an incorrect selection entitling the bettor to receive a consolation payment, pursuant to the provisions §U of this regulation; and
      (b) Other correctly selected finishers in a Lucky Stride wager shall continue to count toward a bettor's eligibility to win.
   (3) If, due to a late scratch, the number of betting interests in a race comprising the Lucky Stride is reduced to fewer than three, the race shall be declared a “no contest,” and the Lucky Stride pool shall be subject to §T of this regulation.
T. Cancellations
   (1) If any of the Lucky Stride races are cancelled or declared “no contest” at any time before Lucky Stride wagering is closed, all Lucky Stride wagers made in connection with the given live racing program on which Lucky Stride wagering was conducted shall be refunded.
   (2) If any of the Lucky Stride races are cancelled or declared “no contest” after Lucky Stride wagering is closed, then:
      (a) For purposes of determining the number of correct selections, each selection made in a Lucky Stride race that is cancelled or declared “no contest” shall be treated as a scratched entry and entitle the bettors to receive a consolation prize as described in §U of this regulation.
      (b) If, after applying §T(2)(a) of this regulation, it remains possible for a bettor to correctly select all of the finishers, in exact order, required to qualify for the major share of the Net Lucky Stride pool as designated by the racing association under §H of this regulation, the Net Lucky Stride pool, plus the Lucky Stride pool carryover, shall be distributed according to §I, §J and §K of this regulation.
      (c) If, after applying §T(2)(a) of this regulation, it becomes impossible for a bettor to correctly select all of the finishers, in exact order, required to qualify for the major share of the Net Lucky Stride pool as designated by the racing association under §H of this regulation:
         1. The major share shall be carried over and added to the major share of the Net Lucky Stride pool on the next live racing program of the race meeting on which Lucky stride wagering is conducted.
         2. Winners of a designated minor share shall receive the percentage of the Net Lucky Stride pool that is designated for that minor share according to §G of this regulation.
   (3) If the Net Lucky Stride pool has been designated for distribution in accordance with §V of this regulation, the provisions of §V of this regulation shall apply.
U. Consolation Payments
   (1) Consolation payments shall be determined from the residual pool of the Net Lucky Stride pool and shall be calculated as follows:
      (i). The residual pool shall be divided among the various minor pools, pro rata, according relative proportion that each pool bears to the total number of minor pools.
      (ii) Consolation payments for bettors sharing in each minor pool shall be divided equally among all bettors in that minor pool who qualify for a consolation payment.
   (2) In respect of each minor share, if no player qualifies for a consolation payment, such portion of the residual pool shall be carried over and added to the major pool for future distribution to any bettor or bettors who qualify to receive the major share.
V. Mandatory Distribution
   (1) The Lucky Stride pool carryover may be designated for distribution on a specified date if:
      (a) It is the closing day of the race meet;
      (b) The association declares its intention to do so at least 24 hours before the opening of Lucky Stride wagering for which there is to be a mandatory distribution; or
      (c) Upon such other condition the Commission may approve.
   (2) If the Lucky Stride pool carryover is designated for a mandatory distribution on a specified date and, on that date, there are no wagers qualifying for the major share, then the following precedence shall be followed in determining winning wagers for the Net Lucky Stride pool and the Lucky Stride pool carryover:
      (a) The major share of the Net Lucky Stride pool, the principal minor share of the Net Lucky Stride pool and the Lucky Stride pool carryover shall be distributed to those who correctly selected the most finishers, in their exact positions, in the Lucky Stride races with designated additional minor pools also being awarded; and
      (b) If there are no wagers which select even one finisher, in its exact position, in the Lucky Stride races, then all Lucky Stride wagers shall become winners and share 100% of that day's Net Lucky Stride pool and the Lucky Stride pool carryover
   (3) If, for any reason, there is not a mandatory distribution as provided in this subsection, the Lucky Stride pool carryover shall be:
      (a) Deposited in an interest bearing account at a Commission-approved bank; and
      (b) With accrued interest, added to the Net Lucky Stride pool of the next race meet held by the racing association.
W. Upon Commission approval, a racing association may offer a guaranteed pay-out on Lucky Stride wagering by:
   (1) Announcing the amount of the guaranteed pay-out at least 24 hours before the opening of Lucky Stride wagering for which there is to be a guaranteed pay-out; and
   (2) Adding monies to the current Lucky Stride pool carryover in an amount sufficient to satisfy the guaranteed pay-out; however, the added monies shall not be subject to take-out.
X. The purchase and acceptance of a Lucky Stride wager by a bettor shall constitute:
   (1) An acknowledgment of the correctness of the ticket; and
   (2) An agreement to be bound by the terms and provisions of this regulation.
Y. The sale of a Lucky Stride pari-mutuel wager other than from a pari-mutuel wagering machine or over an advance deposit account wagering platform, and the re-sale of a Lucky Stride ticket from one person to another, is prohibited.
Z. Neither a racing association, nor a totalizator company, nor the Commission, nor the jurisdiction where the Commission is located shall be liable to any person for a Lucky Stride ticket which is not:
   (1) A winning wager in accordance with the provisions of this regulation; or
   (2) Delivered, for any reason, including:
      (a) A mechanical malfunction;
      (b) An electrical failure; or
      (c) A machine locking.
AA. This regulation shall be displayed prominently in the betting area of the racing association conducting Lucky Stride wagering.

What is claimed is:

1. A method for conducting a wager, comprising the steps of:
identifying at least four race events, each race event having a predetermined minimum number of participants;
defining the wager by specifying a predictive outcome for each race event;
receiving at least one wager entry, the at least one wager entry including a prediction corresponding to the specified predictive outcome for each race event;
after an actual outcome for each race event has been determined, comparing each actual outcome to each predictive outcome for each received wager entry; and,
for each received wager entry, determining a level of winnings to be awarded based on a result of the comparing step,
wherein for at least a first one of the at least four race events, the specified predictive outcome includes an identification of at least a first-place finisher, a second-place finisher, a third-place finisher, and a fourth-place finisher in a correct order of finish.

2. The method of claim 1, wherein for at least a second one of the at least four race events, the specified predictive outcome includes an identification of a first-place finisher.

3. The method of claim 2, wherein for at least a third one of the at least four race events, the specified predictive outcome includes an identification of one of a first-place finisher and a second-place finisher.

4. The method of claim 1, wherein each of the at least four race events includes at least seven participants.

5. The method of claim 1, wherein the step of determining a level of winnings to be awarded further comprises selecting a highest level of winnings corresponding to a correct match between the predictive outcome and the actual outcome for all of the at least four race events and at least a second highest level of winnings corresponding to a correct match between the predictive outcome and the actual outcome for all but one of the at least four events, including a correct match corresponding to the first one of the at least four race events.

6. The method of claim 1, wherein the identifying step further comprises identifying at least six horse race events, a first one of the at least six horse race events having a predetermined minimum number of participant horses that is greater than or equal to seven; and
wherein for the first one of the at least six horse race events, the specified predictive outcome includes an identification of at least a first-place finisher, a second-place finisher, a third-place finisher, a fourth-place finisher, a fifth-place finisher, a sixth-place finisher, and a seventh-place finisher in a correct order of finish; and
wherein for a second one of the at least six horse race events, the specified predictive outcome includes an identification of a first-place finisher; and
wherein for a third one of the at least six horse race events, the specified predictive outcome includes an identification of one of a first-place finisher and a second-place finisher; and
wherein for a fourth one of the at least six horse race events, the specified predictive outcome includes an identification of one of a first-place finisher, a second-place finisher, and a third-place finisher; and
wherein for a fifth one of the at least six horse race events, the specified predictive outcome includes an identification of one of a first-place finisher, a second-place finisher, a third-place finisher, and a fourth-place finisher; and
wherein for a sixth one of the at least six horse race events, the specified predictive outcome includes an identification of one of a first-place finisher, a second-place finisher, a third-place finisher, a fourth-place finisher, and a fifth-place finisher.

7. The method of claim 6, wherein the step of determining a level of winnings further comprises determining a first level of winnings corresponding to a correct match between the predictive outcome and the actual outcome for all of the at least six horse race events, and determining a second level of winnings corresponding to a correct match between the predictive outcome and the actual outcome for the first horse race event and four of the second, third, fourth, fifth, and sixth horse race events.

8. The method of claim 7, wherein the step of determining a level of winnings further comprises determining at least one of a third, fourth, fifth, sixth, and seventh level of winnings, the third level corresponding to a correct match between the predictive outcome and the actual outcome for the first horse race event and three of the second, third, fourth, fifth, and sixth horse race events; the fourth level corresponding to a correct match between the predictive outcome and the actual outcome for the first horse race event and two of the second, third, fourth, fifth, and sixth horse race events; the fifth level corresponding to a correct match between the predictive outcome and the actual outcome for the first horse race event and one of the second, third, fourth, fifth, and sixth horse race events; the sixth level corresponding to a correct match between the predictive outcome for the first horse race event and none of the second, third, fourth, fifth, and sixth horse race events; and the seventh level corresponding to a correct match between the predictive outcome and the actual outcome for all five of the second, third, fourth, fifth, and sixth horse race events and an incorrect match between the predictive outcome and the actual outcome for the first horse race event.

9. The method of claim 7, wherein the step of determining a level of winnings further comprises determining a third level of winnings corresponding to a correct match between the predictive outcome and the actual outcome for one or more of the second, third, fourth, fifth, and sixth horse race events and, for the first horse race event, a correct identification of the first-place finisher, the second-place finisher, the third-place finisher, the fourth-place finisher, the fifth-place finisher, the sixth-place finisher, and the seventh-place finisher in an incorrect order of finish.

10. A system for conducting a wager, the system comprising a server computer and at least one client computer, the client computer being in communication with the server computer via a network, wherein the server computer is configured to:
communicate a set of parameters defining the wager to the at least one client computer, the parameters including an identification of at least four race events and a specified predictive outcome for each race event;
receive from the at least one client computer at least one wager entry, the at least one wager entry including a prediction corresponding to the specified predictive outcome for each race event;
after an actual outcome for each race event has been determined, for each received wager entry, compare the actual outcome to the specified predictive outcome for each race event; and
based on a result of the comparing, determine a level of winnings to be awarded for each received wager entry,
wherein for at least one of the at least four race events, the specified predictive outcome includes an identification of at least a first-place finisher, a second-place finisher, a third-place finisher, and a fourth-place finisher in a correct order of finish.

11. The system of claim 10, wherein for at least a second one of the at least four race events, the specified predictive outcome includes an identification of a first-place finisher.

12. The system of claim 11, wherein for at least a third one of the at least four race events, the specified predictive outcome includes an identification of one of a first-place finisher and a second-place finisher.

13. The system of claim 10, wherein each of the at least four race events includes at least seven participants.

14. The system of claim 10, wherein the server computer is further configured to determine a highest level of winnings corresponding to a correct match between the predictive outcome and the actual outcome for all of the at least four race events, and to determine at least a second highest level of winnings corresponding to a correct match between the predictive outcome and the actual outcome for all but one of the at least four events, including a correct match corresponding to the first one of the at least four race events.

15. The system of claim 10, wherein the server computer is further configured to communicate to the at least one client computer an identification of at least six horse race events, a first one of the at least six horse race events having a predetermined minimum number of participant horses that is greater than or equal to seven; and
wherein for the first one of the at least six horse race events, the specified predictive outcome includes an identification of at least a first-place finisher, a second-place finisher, a third-place finisher, a fourth-place finisher, a fifth-place finisher, a sixth-place finisher, and a seventh-place finisher in a correct order of finish; and
wherein for a second one of the at least six horse race events, the specified predictive outcome includes an identification of a first-place finisher; and
wherein for a third one of the at least six horse race events, the specified predictive outcome includes an identification of one of a first-place finisher and a second-place finisher; and
wherein for a fourth one of the at least six horse race events, the specified predictive outcome includes an identification of one of a first-place finisher, a second-place finisher, and a third-place finisher; and
wherein for a fifth one of the at least six horse race events, the specified predictive outcome includes an identification of one of a first-place finisher, a second-place finisher, a third-place finisher, and a fourth-place finisher; and
wherein for a sixth one of the at least six horse race events, the specified predictive outcome includes an identification of one of a first-place finisher, a second-place finisher, a third-place finisher, a fourth-place finisher, and a fifth-place finisher.

16. The system of claim 15, wherein the server computer is further configured to determine a first level of winnings corresponding to a correct match between the predictive outcome and the actual outcome for all of the at least six horse race events, and to determine a second level of winnings corresponding to a correct match between the predictive outcome and the actual outcome for the first horse race event and four of the second, third, fourth, fifth, and sixth horse race events.

17. The system of claim 16, wherein the server computer is further configured to determine at least one of a third, fourth, fifth, sixth, and seventh level of winnings, the third level corresponding to a correct match between the predictive outcome and the actual outcome for the first horse race event and three of the second, third, fourth, fifth, and sixth horse race events; the fourth level corresponding to a correct match between the predictive outcome and the actual outcome for the first horse race event and two of the second, third, fourth, fifth, and sixth horse race events; the fifth level corresponding to a correct match between the predictive outcome and the actual outcome for the first horse race event and one of the second, third, fourth, fifth, and sixth horse race events; the sixth level corresponding to a correct match between the predictive outcome and the actual outcome for the first horse race event and none of the second, third, fourth, fifth, and sixth horse race events; and the seventh level corresponding to a correct match between the predictive outcome and the actual outcome for all five of the second, third, fourth, fifth, and sixth horse race events and an incorrect match between the predictive outcome and the actual outcome for the first horse race event.

18. The system of claim 16, wherein the server computer is further configured to determine a third level of winnings corresponding to a correct match between the predictive outcome and the actual outcome for one or more of the second, third, fourth, fifth, and sixth horse race events and, for the first horse race event, a correct identification of the first-place finisher, the second-place finisher, the third-place finisher, the fourth-place finisher, the fifth-place finisher, the sixth-place finisher, and the seventh-place finisher in an incorrect order of finish.

19. A wagering game, comprising a plurality of wager entries and a wagering pool,
each of the plurality of wager entries including a predictive outcome for each of at least four predetermined race events,
wherein when an actual outcome for each race event has been determined, a percentage amount of the wagering pool is allocated to each of the plurality of wager entries based on a comparison of each predictive outcome to each actual outcome, and
wherein for at least one of the at least four predetermined race events, the predictive outcome includes an identification of at least a first-place finisher, a second-place finisher, a third-place finisher, and a fourth-place finisher in a correct order of finish.

20. The wagering game of claim 19, wherein for at least a second one of the at least four race events, the predictive outcome includes an identification of a first-place finisher.

21. The wagering game of claim 20, wherein for at least a third one of the at least four race events, the predictive outcome includes an identification of one of a first-place finisher and a second-place finisher.

22. The wagering game of claim 19, wherein each of the at least four race events includes at least seven participants.

23. The wagering game of claim 19, wherein a highest percentage of the wagering pool is allocated to a wager entry that includes a predictive outcome that correctly matches the actual outcome for all of the at least four race events, and at least a second highest percentage of the wagering pool is allocated to a wager entry that includes a predictive outcome that correctly matches the actual outcome for all but one of the at least four race events, including a predictive outcome that correctly matches the actual outcome for the first one of the at least four race events.

24. The wagering game of claim 19, wherein each of the plurality of wager entries includes a predictive outcome of each of at least six predetermined horse race events, a first one of the at least six horse race events having a predetermined minimum number of participant horses that is greater than or equal to seven; and
wherein for the first one of the at least six horse race events, the predictive outcome includes an identification of at least a first-place finisher, a second-place finisher, a third-place finisher, a fourth-place finisher, a fifth-place finisher, a sixth-place finisher, and a seventh-place finisher in a correct order of finish; and
wherein for a second one of the at least six horse race events, the predictive outcome includes an identification of a first-place finisher; and
wherein for a third one of the at least six horse race events, the predictive outcome includes an identification of one of a first-place finisher and a second-place finisher; and
wherein for a fourth one of the at least six horse race events, the predictive outcome includes an identification of one of a first-place finisher, a second-place finisher, and a third-place finisher; and
wherein for a fifth one of the at least six horse race events, the predictive outcome includes an identification of one of a first-place finisher, a second-place finisher, a third-place finisher, and a fourth-place finisher; and
wherein for a sixth one of the at least six horse race events, the predictive outcome includes an identification of one of a first-place finisher, a second-place finisher, a third-place finisher, a fourth-place finisher, and a fifth-place finisher.

25. The wagering game of claim 24, wherein a first level of winnings from the wagering pool is allocated to a wager entry that includes a predictive outcome that correctly matches the actual outcome for all of the at least six horse race events, and a second level of winnings from the wagering pool is allocated to a wager entry that includes a predictive outcome that correctly matches the actual outcome for the first horse race event and four of the second, third, fourth, fifth, and sixth horse race events.

26. The wagering game of claim 25, wherein at least one of a third, fourth, fifth, sixth, and seventh level of winnings from the wagering pool is allocated to a respective wager entry, the third level corresponding to a wager entry that includes a correct match between the predictive outcome and the actual outcome for the first horse race event and three of the second, third, fourth, fifth, and sixth horse race events; the fourth level corresponding to a wager entry that includes a correct match between the predictive outcome and the actual outcome for the first horse race event and two of the second, third, fourth, fifth, and sixth horse race events; the fifth level corresponding to a wager entry that includes a correct match between the predictive outcome and the actual outcome for the first horse race event and one of the second, third, fourth, fifth, and sixth horse race events; the sixth level corresponding to a wager entry that includes a correct match between the predictive outcome and the actual outcome for the first horse race event and none of the second, third, fourth, fifth, and sixth horse race events; and the seventh level corresponding to a wager entry that includes a correct match between the predictive outcome and the actual outcome for all five of the second, third, fourth, fifth, and sixth horse race events and an incorrect match between the predictive outcome and the actual outcome for the first horse race event.

27. The wagering game of claim 25, wherein a third level of winnings from the wagering pool is allocated to a wager entry that includes a predictive outcome that correctly matches the actual outcome for one or more of the second, third, fourth, fifth, and sixth horse race events and a correct identification of the first-place finisher, the second-place finisher, the third-place finisher, the fourth-place finisher, the fifth-place finisher, the sixth-place finisher, and the seventh-place finisher in an incorrect order of finish.
